(19) United States
(12) Patent Application Publication
(10) Pub. No.: US 2007/0172080 A1
(43) Pub. Date: Jul. 26, 2007

(54) Acoustic feedback suppression

(75) Inventors: Cornelis Pieter Janse, Eindhoven (NL); Chien Chao Tchang, Bavel (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,750

(22) PCT Filed: Jan. 28, 2005
(86) PCT No.: PCT/IB05/50377

§ 371 Date: Aug. 7, 2006

(30) Foreign Application Priority Data
Feb. 11, 2004 (EP) 04100516.6

(51) Int. Cl. H04B 15/00

(52) U.S. Cl. 381/93

(57) ABSTRACT

A device (1) for acoustic feedback compensation comprises an adaptive filter (4), an adjustment unit (5) for adjusting coefficients of the adaptive filter, a combination unit (3) for subtracting an adaptive filter signal from an input signal so as to produce a residual signal, and a noise unit (8) for producing a noise signal. The noise unit (8) is arranged for producing masked noise on the basis of the residual signal, a noise signal having a frequency spectrum controlled by the residual signal. An auditory masking model may be used to shape the noise spectrum. The noise signal may have a smaller amplitude than the residual signal at frequencies where the residual signal has a relatively large amplitude, and a larger amplitude than the residual signal at some frequencies where the residual signal has a relatively small amplitude.

The present invention relates to acoustic feedback suppression. More in particular, the present invention relates to a device for acoustic feedback suppression suitable for use in sound amplification systems.

It is a well-known problem in sound amplification systems that sound can be fed back from a loudspeaker to a microphone, leading to so-called “howling”: due to the feedback, certain frequencies of the sound are undesirably amplified by the system and produce a howling effect. Various attempts have been made to tackle this problem. Some of the proposed solutions involve a filter that models and imitates the sound transmission characteristics of the air path between the loudspeaker and the microphone. The filter is used to produce a compensation signal that is subtracted from the microphone signal. The resulting residual signal is, ideally, free from the undesired effects of feedback.

As the characteristics of the air path imitated by the filter may vary in time, for example due to temperature changes or the movement of objects or persons, the filter is typically an adaptive filter and its filter coefficients are periodically or continually adjusted, that is, adapted to the changed environment. To this end, acoustic feedback compensation circuits typically include an adjustment unit for adjusting the coefficients of the adaptive filter. Such an adjustment unit may be arranged for determining the correlation between the residual signal mentioned above and the output signal, and adjusting the filter coefficients so as to minimize said correlation. The speed of adaptation of the filter coefficients generally depends on the levels of the signals fed to the adjustment unit.

The adjustment unit may, however, introduce errors when the output signal and the residual signal are inherently correlated, for example when the output signal is obtained by amplifying the residual signal. For this reason it has been proposed to decorrelate the residual signal and the output signal, for example by shifting the frequency of the input signal. An example of this approach is disclosed in U.S. Pat. No. 5,748,751. Although this frequency shift approach is very effective, it cannot be used in all applications as the frequency shift may be audible and may not be appreciated by the users of the sound amplification system.

It has also been proposed to inject a noise signal that is not correlated to the input signal and to use the residual signal and the injected noise signal to adjust the filter coefficients. An example of this approach, for the specific purpose of compensating acoustic feedback in a hearing aid, is disclosed in European Patent Application EP 0 415 677. The noise may have an essentially flat level over the frequency range of the hearing aid. Alternatively, the noise level may vary as a function of the level of the input signal, keeping the ratio of the signal to noise more or less constant. To this end, the noise signal is multiplied by a value that depends on the residual signal level.

Although this injected noise approach may be effective, it has the drawback that to provide a reasonable speed of adaptation of the filter coefficients, the noise level has to be relatively high. This may be less of a problem in the field of hearing aids where some audible noise may be acceptable as intelligibility is more important than sound quality, and where the perceived noise level may still be very low as the typical user has a narrow effective frequency range. However, a high noise level is clearly undesired in sound amplification systems where speech or music is amplified over a relatively wide frequency range, in particular when used in large rooms and corridors. In addition, adaptive filters used in sound amplification systems such as public address systems may have a filter length that is 10 to 30 times as long as the filter length of a hearing aid and therefore have a much lower adaptation speed at corresponding injected noise levels.

Merely reducing the noise level is not a practical solution as at low noise levels the adaptation speed of the adaptive filter coefficients is relatively low, which may give rise to undesirable transients in the sound signal and even howling if the acoustic path changes during the adaptation process.

It is an object of the present invention to overcome these and other problems of the Prior Art and to provide a device for acoustic feedback compensation that allows a relatively high adaptation speed at relatively low noise levels.

It is another object of the present invention to provide a sound system in which such a device for acoustic feedback compensation is utilized. Accordingly, the present invention provides a device for acoustic feedback compensation, the device comprising:
an adaptive filter for providing an acoustic feedback compensation signal,
a first combination unit for combining the acoustic feedback compensation signal with an input signal so as to produce a residual signal,
a noise unit for producing a noise signal,
an adjustment unit for adjusting coefficients of the adaptive filter, and
a second combination unit for combining the residual signal and the noise signal so as to form an output signal,
   wherein the noise unit is arranged for providing a noise signal having a frequency spectrum controlled by the residual signal.

By providing a noise signal having a frequency spectrum controlled by the residual signal it is possible to achieve a better trade-off between the perceived noise level and the filter adaptation speed. In particular, a higher filter adaptation speed can be obtained compared to arrangements in which a noise signal having an unchanging frequency spectrum is used. In addition, noise that is adapted to the residual signal allows a better masking of the injected noise signal.

It is noted that in the present invention, not only the amplitude but also the shape of the frequency spectrum of the noise signal may be controlled by the residual signal. The residual signal may thus be said to shape the spectrum of the noise signal so as to obtain an optimal masking.

In Prior Art arrangements, the noise level is lower than the residual signal level to achieve a good masking of the noise and thereby to prevent the noise from being audible. When constant noise levels are used, this requires the noise level to be significantly lower than the residual signal level. In the present invention, however, where the noise level is controlled by the residual signal, this requirement no longer applies to all frequencies, and at some frequencies the noise level may exceed the residual signal level. This is very advantageous as any mis-adaptation of the adaptive filter is proportional to the (residual) signal to (injected) noise ratio and the adaptation speed of the filter. A relatively high noise level at a constant adaptation speed will therefore result in a minimal mis-adaptation of the filter and consequently a high sound quality. Alternatively, the adaptation speed can be made proportional to the (residual) signal to (injected) noise ratio, keeping the mis-adaptation of the adaptive filter constant. A high relative noise level then results in a higher adaptation speed.

In a preferred embodiment, the noise unit is arranged for providing a noise signal in accordance with an auditory masking model. That is, a model based upon the human perception of noise in the presence of a wanted signal is used to control the frequency spectrum of the noise signal. Such an auditory masking model, which serves to maximize the noise level while minimizing the perception of the noise, may be known per se. Some auditory masking models allow the noise level to exceed the level of the residual signal at some frequencies.

In a preferred embodiment, therefore, the noise unit is arranged for providing a noise signal having a smaller amplitude than the residual signal at frequencies where the residual signal has a relatively large amplitude and having a larger amplitude than the residual signal at frequencies where the residual signal has a relatively small amplitude. In other words, the noise unit is arranged for producing noise having a smaller amplitude than the residual signal when the residual signal is at a peak, and a larger amplitude than the residual signal when the residual signal is at a trough. Accordingly, the noise signal is at least at some frequencies larger than the residual signal, thus allowing a fast adaptation of the adaptive filter.

It has been found that it is not necessary for the noise signal to have a smaller amplitude than the residual signal at all frequencies. By ensuring that the noise level is smaller than the residual signal level at those frequencies where the residual signal level is relatively high, a sufficient masking of the noise signal is achieved. As a result, the noise signal is not audible, not even at the frequencies where its amplitude exceeds that of the residual signal.

In an advantageous embodiment, the noise unit comprises a random phase unit for producing a random phase. By providing a random phase, it is ensured that the noise signal is not correlated to any other signal, in particular not to the residual signal.

It is further advantageous if the noise unit comprises a spectrum unit for producing a frequency spectrum of the residual signal, a magnitude unit for determining the magnitude of the frequency spectrum, a noise magnitude unit for determining the magnitude of masked noise relative to the magnitude of the frequency spectrum, and a reconstruction unit for reconstructing a masked noise signal on the basis of the magnitude of masked noise and the random phase. In this embodiment, the noise signal is based upon the residual signal, but is decorrelated due to the random phase and is amplitude adjusted to provide a suitable masking. It is noted that the noise magnitude unit determines a magnitude which is dependent on the frequency and which, in particular, is dependent on the amplitude of the residual signal at a particular frequency or in a particular frequency band.

Advantageously, the adjustment unit is coupled to the first combination unit and the noise unit so as to adjust coefficients of the adaptive filter on the basis of the residual signal and the noise signal. It may further be advantageous to arrange the adjustment unit for a constant mis-adaptation of the adaptive filter, making the adaptation speed of the adaptive filter for all frequencies inversely proportional to the (residual) signal to (injected) noise ratio. This mis-adaptation is preferably chosen to be relatively small so as to cause only a slight decrease in the sound quality.

If the device of the present invention further comprises an amplification unit, it can be used as an sound amplification device.

The present invention also provides a system for sound amplification, comprising at least one microphone, at least one loudspeaker and a device as defined above.

The present invention additionally provides a method of acoustic feedback compensation, the method comprising the steps of:
combining an input signal with an acoustic feedback compensation signal so as to produce a residual signal,
producing a noise signal,
combining the residual signal and the noise signal so as to form an output signal, and
adaptively filtering the output signal to provide the acoustic feedback compensation signal,
   wherein the noise signal has a frequency spectrum controlled by the residual signal.

Preferably, the noise signal has a smaller amplitude than the residual signal at frequencies where the residual signal has a relatively large amplitude and a larger amplitude than the residual signal at frequencies where the residual signal has a relatively small amplitude.

The present invention further provides a computer program product for carrying out the method as defined above.

The present invention will further be explained below with reference to exemplary embodiments illustrated in the accompanying drawings, in which:

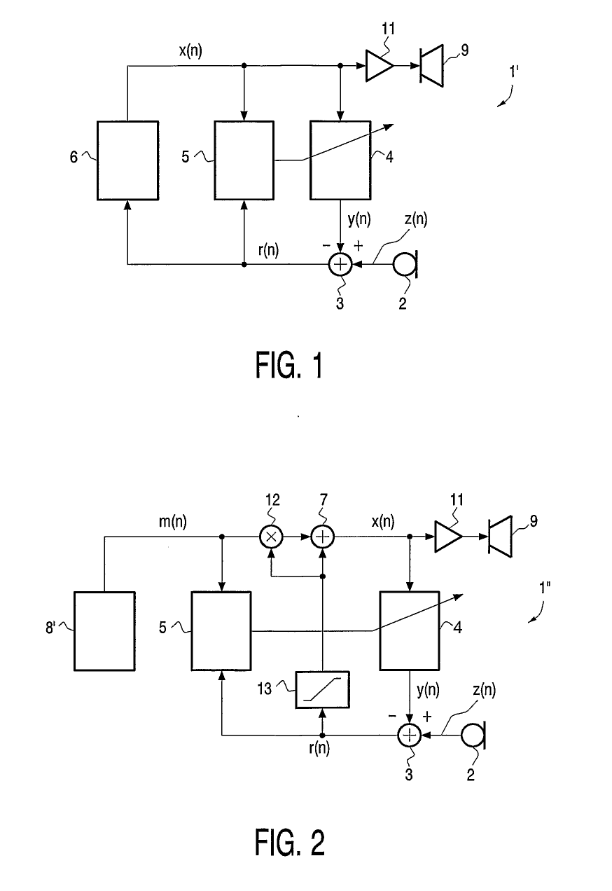

FIG. 1 schematically shows a first device for acoustic feedback compensation according to the Prior Art.

FIG. 2 schematically shows a second device for acoustic feedback compensation according to the Prior Art.

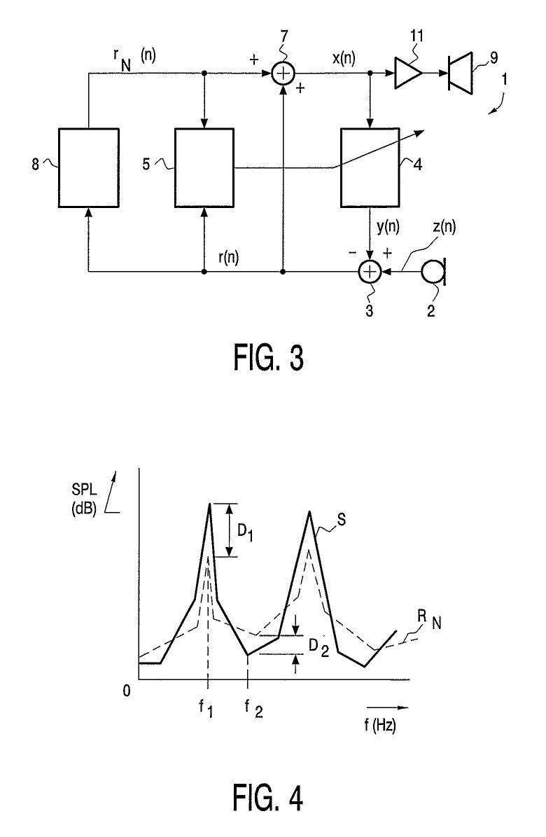

FIG. 3 schematically shows a first embodiment of a device for acoustic feedback compensation according to the invention.

FIG. 4 schematically shows noise masking in accordance with the present invention.

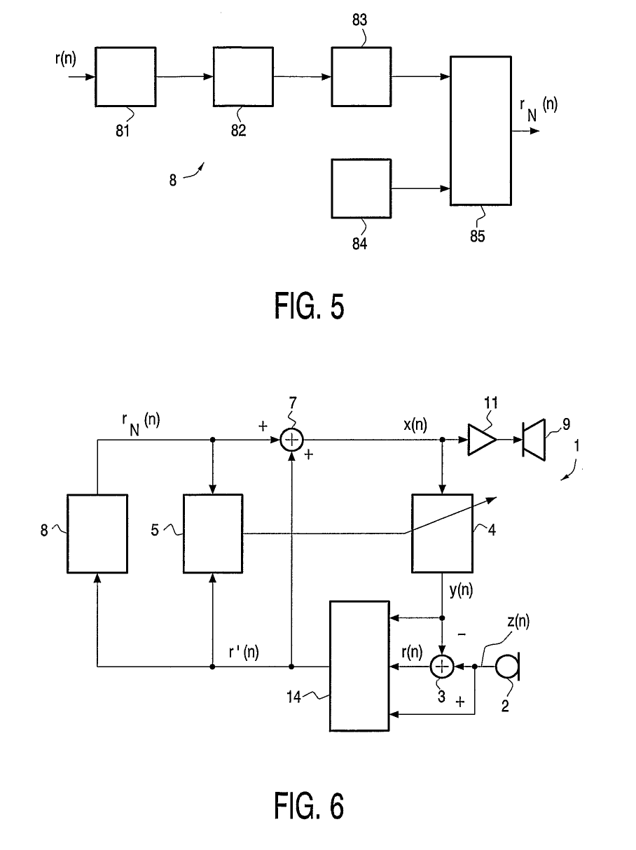

FIG. 5 schematically shows a noise unit in accordance with the present invention.

FIG. 6 schematically shows a second embodiment of a device for acoustic feedback compensation according to the invention.

The Prior Art device 1′ schematically shown in FIG. 1 comprises a signal combination unit 3, an adaptive filter 4, an adjustment unit 5 and a decorrelator 6. The device 1′ is coupled to a microphone 2 which produces an input signal z(n), and a loudspeaker 9 which renders an output signal x(n) of the device 1′. The adaptive filter 4 produces an acoustic feedback compensation signal y(n) which is subtracted from the input signal z(n) in the combination (adder) circuit 3, resulting in a residual signal r(n). The decorrelator 6 decorrelates the residual signal r(n) and produces the output signal x(n) which is amplified by the (optional) amplifier 11. It is noted that any A/D (analog/digital) and D/A (digital/analog) converters are not shown in FIG. 1 for the sake of clarity.

The adjustment unit 5 adjusts the coefficients of the adaptive filter 4 on the basis of the residual signal r(n) and the output signal x(n). Typically, the adjustment unit 5 is a correlator which determines any (remaining) correlation between the residual signal r(n) and the output signal x(n). The adjustment unit 5 adjusts the coefficients of the adaptive filter in such a way that the correlation between r(n) and x(n) is minimized and, ideally, vanishes.

Without the decorrelator 6, the output signal x(n) would be substantially equal to the residual signal r(n) and, as a result, the adaptive filter 4 would attempt to cancel the residual signal, which would cause distortion of the signal. Although other circuit components such as amplifiers could be present, as a result of which x(n) would not be equal to r(n), the signals x(n) and r(n) would still be strongly correlated and the input signal z(n) would be substantially cancelled by the adaptive filter.

Typical decorrelators involve frequency shifting. Although frequency shifting is very effective in decorrelating the signal, its effects are often audible, in particular in music signals. Frequency shifting decorrelators are therefore not universally applicable.

An alternative solution is used in the Prior Art device 1″ of FIG. 2 where a noise generator 8′ is used instead of the decorrelator 6 of FIG. 1. This known acoustic feedback compensation device 1″ for hearing aids, which is described in more detail in European Patent Application EP 0 415 677, further comprises a limiter 13 for limiting the amplitude of the residual signal r(n). The output signal of the noise generator 8′ is fed to the adjustment unit 5, as is the residual signal, to adjust the coefficients of the adaptive filter 4. The noise signal m(n) generated by the noise generator 8′ is added to the output signal x(n) in a second combination unit 7 and thus contributes to the filtered signal y(n).

In the device of FIG. 2, the noise level in the output signal x(n) is controlled by the multiplication unit 12 which controls the level of the noise signal added to the (amplitude limited) residual signal. The level of the injected noise is controlled to vary as a function of the level of the residual signal, keeping the ratio of (residual) signal to noise substantially constant.

However, a constant signal to noise ratio implies that the noise level is low when the signal level is low, resulting in a low adaptation speed of the adaptive filter 4. The present invention provides a solution for this problem.

The device 1 of the present invention shown merely by way of non-limiting example in FIG. 3 also comprises a first combination unit 3, an adaptive filter 4, an adjustment unit 5, a second combination unit 7, a noise (generator) unit 8 and an (optional) amplifier 11. The adjustment unit 5, which may be a correlator, receives both the residual signal r(n) and the noise signal r_{N}(n) to produce suitable filter adjustment signals for adjusting the coefficients of the adaptive filter 4. The noise signal r_{N}(n) produced by the noise generator 8 is “injected” into the output signal x(n) at the second combination unit 7, and is also fed to the adjustment unit 5. In contrast to the device of FIG. 2, the noise unit 8 of FIG. 3 produces noise on the basis of the residual signal r(n). This will be further explained with reference to FIG. 4.

In the example of FIG. 4, the sound pressure level SPL in dB (decibel) is shown as a function of the frequency f in Hz (hertz). The sound pressure level corresponds with the (absolute value of the) frequency spectrum and indicates the sound level (amplitude) at a certain frequency. The solid graph S represents the frequency spectrum of the residual signal r(n) while the interrupted line R_{N} indicates the frequency spectrum of the (injected) noise signal r_{N}(n) produced by the noise unit 8 of FIG. 3.

In the example of FIG. 4, the frequency spectrum S has two peaks and a trough. The first peak is at frequency f₁ while the trough is at frequency f₂. The noise frequency spectrum R_{N} varies with the frequency and also has peaks and a trough. At frequency f₁, the level of R_{N} is D₁ dB lower than the level of S to provide a sufficient noise masking at this frequency. At frequency D₂, however, the level of R_{N} is D₂ dB higher than the level of S. That is, at the trough of the graph the noise level exceeds the signal level. It has been found that this still provides sufficient masking of the noise signal while allowing a rapid adaptation of the filter coefficients at these frequencies.

It is noted that determining the magnitude of frequency spectrum R_{N} may be carried out using well-known masking models as described, for instance, in the paper “Perceptual coding of digital audio” by T. Painter and A. Spanias, Proceedings of the IEEE, vol. 88, pp. 451-513, 2000. Such masking models have been used for audio coding applications but not for acoustic feedback suppression.

The noise unit 8 is arranged for repeatedly determining the noise signal r_{N}(n), for example every 10 or 20 ms, although both larger and smaller time intervals may be used, for example every 5, 50, or 100 ms. It is noted that each time the noise signal r_{N}(n) and its spectrum R_{N} is determined, the ratio of the noise signal to the residual signal will generally be different for any one frequency. Thus the noise level at any one frequency, for example frequency f₂ (FIG. 4), may at one moment be larger and at another moment be smaller than the residual signal level. In this way, for any one frequency the adaptation of the filter coefficients will at some point in time be carried out using a relatively high noise level, leading to a fast and effective adaptation.

An exemplary embodiment of the noise unit 8 is schematically shown in more detail in FIG. 5. In the embodiment shown, the noise unit 8 comprises a spectrum unit 81 for producing a frequency spectrum of the residual signal r(n), a magnitude unit 82 for determining the magnitude of the frequency spectrum, a noise magnitude unit 83 for determining the magnitude of masked noise relative to the magnitude of the frequency spectrum, a random phase unit 84 for producing a random phase, and a reconstruction unit 85 for reconstructing a masked noise signal on the basis of the magnitude of masked noise and the random phase.

As mentioned above, the random phase effectively decorrelates the residual signal r(n) and the noise signal r_{N}(n). The noise magnitude unit 83 determines the magnitude or level of the noise signal r_{N}(n) for various frequencies, for example as illustrated in FIG. 4. The noise magnitude unit 83 advantageously utilizes an auditory masking model as discussed above to adapt the frequency spectrum of the noise to the frequency spectrum of the residual signal so as to maximize the noise level at all frequencies while minimizing or eliminating the perceived noise level.

An alternative embodiment of the device 1 of the present invention is illustrated in FIG. 6 where the device is shown to additionally comprise a dynamic echo suppressor 14. Such a dynamic echo suppressor serves to temporarily decrease the amplitude of the residual signal when changes in the acoustic path cause the acoustic feedback compensation signal produced by the adaptive filter to contain a phase error.

The dynamic echo suppressor 14 receives the acoustic feedback compensation signal y(n), the residual signal r(n) and the input signal z(n) to produce an echo compensated residual signal r′(n). The dynamic echo suppressor 14 modifies the amplitude of the frequency components of the input signal without changing its phase (apart from a pure delay). This is achieved by determining the frequency spectrum (Fourier transform) of both the acoustic feedback compensation signal y(n), the input signal z(n) and the residual signal r(n) so as to obtain transformed signals Y, Z and R, determining the magnitude of the transformed signals Y, Z and R and the phase of R, using the magnitudes of Y, Z and R to obtain a combined transformed signal R″ and reconstructing the time signal r′(n) using the magnitude of the combined transformed signal R″ and the phase of R. A dynamic echo suppressor of this type is described in United States Patent Application US 2003/0026437, the entire contents of which are herewith incorporated in this document.

It is noted that in the above discussion it has been assumed that all signals are digital signals having certain values at a certain discrete point in time (n). However, the present invention is not so limited and analog embodiments can also be envisaged. Similarly, the present invention has been explained with reference to devices coupled to a single microphone and a single loudspeaker, but the invention can also be applied using multiple microphones and/or loudspeakers or equivalent transducers. The present invention is particularly suitable for, but not limited to, public address systems, conference systems and in-car communication systems.

The present invention is based upon the insight that an injected noise signal having a frequency spectrum controlled by the residual signal can be used in a device comprising an adaptive filter to obtain a rapid adaptation of the filter coefficients while preventing any noise becoming audible. The present invention benefits from the further insights that an auditory masking model may advantageously be used for determining the injected noise in adaptive filter devices, and that as a result the level of masked noise may exceed the level of the masking signal at certain frequencies where the level of the masking signal is relatively low, provided that the level of the masked noise is lower than the level of the masking signal at other frequencies.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

Under computer program product should be understood any physical realization, e.g. an article of manufacture, of a collection of commands enabling a processor—generic or special purpose—, after a series of loading steps to get the commands into the processor, to execute any of the characteristic functions of an invention. In particular the computer program product may be realized as program code, processor adapted code derived from this program code, or any intermediate translation of this program code, on a carrier such as e.g. a disk or other plug-in component, present in a memory, temporarily present on a network connection—wired or wireless—, or program code on paper. Apart from program code, invention characteristic data required for the program may also be embodied as a computer program product.

It will be understood by those skilled in the art that the present invention is not limited to the embodiments illustrated above and that many modifications and additions may be made without departing from the scope of the invention as defined in the appending claims.

1. A device (1) for acoustic feedback compensation, the device comprising:
an adaptive filter (4) for providing an acoustic feedback compensation signal,
a first combination unit (3) for combining the acoustic feedback compensation signal with an input signal so as to produce a residual signal,
a noise unit (8) for producing a noise signal,
an adjustment unit (5) for adjusting coefficients of the adaptive filter, and
a second combination unit (7) for combining the residual signal and the noise signal so as to form an output signal, wherein the noise unit (8) is arranged for providing a noise signal having a frequency spectrum (R_{N}) controlled by the residual signal.

2. The device according to claim 1, wherein the noise unit (8) is arranged for providing a noise signal in accordance with an auditory masking model.

3. The device according to claim 1, wherein the noise unit (8) is arranged for providing a noise signal having a smaller amplitude than the residual signal at frequencies where the residual signal has a relatively large amplitude and having a larger amplitude than the residual signal at least at some frequencies where the residual signal has a relatively small amplitude.

4. The device according to claim 1, wherein the noise unit (8) is arranged for repeatedly adapting the frequency spectrum of the noise signal to the residual signal.

5. The device according to claim 4, wherein the noise unit (8) is arranged for adapting the frequency spectrum of the noise signal at intervals of less than 100 ms, preferable less than 30 ms, more preferably about 15 ms.

6. The device according to claim 1, wherein the noise unit (8) comprises a random phase unit (84) for producing a random phase.

7. The device according to claim 6, wherein the noise masking unit (8) comprises a spectrum unit (81) for producing a frequency spectrum of the residual signal, a magnitude unit (82) for determining the magnitude of the frequency spectrum, a noise magnitude unit (83) for determining the magnitude of masked noise relative to the magnitude of the frequency spectrum, and a reconstruction unit (85) for reconstructing a masked noise signal on the basis of the magnitude of masked noise and the random phase.

8. The device according to claim 1, wherein the adjustment unit (5) is coupled to the first combination unit (3) and the noise unit (8) so as to adjust coefficients of the adaptive filter on the basis of the residual signal and the noise signal.

9. The device according to claim 8, wherein the adjustment unit (5) is arranged for a constant mis-adaptation of the adaptive filter so as to achieve a high adaptation speed.

10. The device according to claim 1, further comprising an amplification unit (11).

11. The device according to claim 1, further comprising a dynamic echo suppressor (14) arranged for suppressing echoes in the residual signal.

12. The device according to claim 11, wherein the dynamic echo suppressor (14) is arranged for receiving the acoustic feedback compensation signal, the input signal and the residual signal so as to produce an echo suppressed residual signal.

13. A system for sound amplification, comprising at least one microphone (2), at least one loudspeaker (9) and a device (1) according to claim 1.

14. A method of acoustic feedback compensation, the method comprising the steps of:
combining an input signal with an acoustic feedback compensation signal so as to produce a residual signal,
producing a noise signal,
combining the residual signal and the noise signal so as to form an output signal, and
adaptively filtering the output signal to provide the acoustic feedback compensation signal, wherein the noise signal has a frequency spectrum controlled by the residual signal.

15. The method according to claim 14, wherein the noise signal is provided in accordance with an auditory masking model.

16. The method according to claim 14, wherein the noise signal has a smaller amplitude than the residual signal at frequencies where the residual signal has a relatively large amplitude and a larger amplitude than the residual signal at least at some frequencies where the residual signal has a relatively small amplitude.

17. The method according to claim 14, wherein the frequency spectrum of the noise signal is repeatedly adapted to the residual signal.

18. The method according to claim 14, wherein the frequency spectrum of the noise signal is adapted at intervals of less than 100 ms, preferable less than 30 ms, more preferably about 15 ms.

19. The method according to claim 14, wherein the noise signal has a random phase.

20. A computer program product for carrying out the method according to claim 14.
